(19) United States
(12) Patent Application Publication
(10) Pub. No.: US 2012/0311214 A1
(43) Pub. Date: Dec. 6, 2012

(54) ARBITRATION CIRCUIT AND ARBITRATION METHOD THEREOF

(75) Inventor: Ming-Chieh Lin, Hsinchu County (TW)

(73) Assignee: NOVATEK MICROELECTRONICS CORP., Hsinchu (TW)

(21) Appl. No.: 13/275,279

(22) Filed: Oct. 17, 2011

(30) Foreign Application Priority Data
May 30, 2011 (TW) 100118867

(51) Int. Cl. G06F 13/18

(52) U.S. Cl. 710/244

(57) ABSTRACT

An arbitration circuit and an arbitration method thereof are provided to arbitrate requests from a plurality of data processing devices for access to a shared resource. The arbitration method has steps of generating a first data stream for respectively identifying whether the data processing devices are currently serviced, generating a second data stream for identifying whether the data processing devices issue any request for access the shared resource, and performing AND operations on the first and second data streams in parallel to generate a third data stream that is used for determining which of the requests may be granted. Because the requests are processed in parallel, the arbitration time can be reduced.

### CROSS-REFERENCE TO RELATED APPLICATION

This application claims the priority benefit of Taiwan application serial no. 100118867, filed on May 30, 2011. The entirety of the above-mentioned patent application is hereby incorporated by reference herein and made a part of this specification.

### BACKGROUND OF THE INVENTION

1. Field of the Invention

The invention relates to an arbitration circuit and an arbitration method thereof and more particularly to an arbitration circuit and an arbitration method thereof capable of processing a plurality of requests in parallel.

2. Description of Related Art

In a conventional computer system, when various peripheral devices request accesses to system resources (e.g. CPU, bus bandwidth, allocation address, I/O ports, memory, etc), an arbitration is necessary to enable an effective sharing of limited system resources. Taking a platform using a common bus (e.g. an Advanced RISC Machine (ARM) platform) for an example, there could be a plurality of intellectual property (IP) cores on any given platform, and IP cores would then need an arbitration circuit in order to determine which IP core is permitted to use the common bus. An arbitration circuit must process requests from a plurality of IP cores fairly. Otherwise, abnormality will result in the system.

Generally, an arbitration circuit determines access sequences of IP cores by the round-robin method. Although using the round-robin method to arbitrate requests is fair, when the method is performed, a conventional arbitration circuit must determine which request should be granted through sequentially analyzing each request from the IP cores. The serial determination would result in a very long determination time, such that the efficiency thereof would be extremely low. More particularly when the number of the IP cores increases, the determination time would also increase correspondingly.

Please refer to FIG. 1, a functional block diagram of a conventional arbitration circuit 10 applied to a plurality of data processing devices IP1-IP3 and a shared resource 20. As shown in FIG. 1, there is a plurality of data processing devices issuing requests to the arbitration circuit 10 for access to the shared resource 20. In this case, there are four data processing devices IP0, IP1, IP2 and IP3. After the arbitration circuit 10 receives the requests from the data processing devices IP0-IP3, the arbitration circuit 10 processes the requests form the data processing devices IP0-IP3 according to a priority sequence of the data processing devices IP0-IP3 for access to the shared resource 20. Moreover, when the arbitration circuit 10 arbitrates the requests from each data processing device, the arbitration circuit 10 could adopt the round-robin method.

Please refer to FIG. 2 which illustrates the arbitration circuit 10 processing requests from data processing devices sequentially by the round-robin method in order to decide the highest priority. The sequence of the data processing devices IP0-IP3 to obtain the highest priority for the arbitration circuit 10 is IP0→IP1→IP2→IP3→IP0 and so on. Each of the data processing devices IP0-IP3 can obtain the highest priority based on the sequence, and requests of the data processing device having the highest priority is to be processed first. Moreover, when one of the data processing devices obtains the highest priority, priorities of other data processing devices decrease sequentially. For example, when the data processing device IP0 obtains the highest priority, the priority sequence of the arbitration circuit 10 to process requests from the data processing devices is IP0→IP1→IP2→IP3; when the data processing device IP1 obtains the highest priority, the priority sequence of the arbitration circuit 10 to process requests form the data processing devices is IP1→IP2→IP3→IP0; and so on.

However, in order to accomplish the sequence shown in FIG. 2, the arbitration circuit 10 must sequentially analyze each of the requests from the data processing devices IP0-IP3 so as to determine which request should be granted. Please refer to FIG. 3 which illustrates the pseudo-code executed by the arbitration circuit 10 of FIG. 1 while the arbitration circuit is arbitrating the requests from the data processing devices IP0-IP3. Firstly, the arbitration circuit 10 will determine which data processing device is currently serviced. Then, the arbitration circuit 10 determines whether any request is received from the data processing devices IP0-IP3 respectively according to the priority sequence of the data processing devices IP0-IP3. Since the determinations are serial, it would result in a very long determination time, and the efficiency thereof would be extremely low.

### SUMMARY OF THE INVENTION

The invention is directed to an arbitration method capable of arbitrating requests from a plurality of data processing devices for access to a shared resource, so as to reduce the time of arbitration.

The invention is further directed to an arbitration circuit capable of arbitrating requests from a plurality of data processing devices for access to a shared resource, so as to increase the speed of arbitration.

The present invention provides an arbitration method for arbitrating requests from a plurality of data processing devices for access to a shared resource. The arbitration method comprises generating a first data stream according to current service statuses of the data processing devices. The first data stream is used for respectively identifying whether the data processing devices are currently serviced. The arbitration method further comprises generating a second data stream according to the requests of the data processing devices for access to the shared resource. The second data stream is used for identifying whether the data processing devices issue any request for access to the shared resource. The arbitration method further comprises performing a plurality of AND operations on corresponding bits of the first data stream and the second data stream in parallel to generate a plurality of bits of a third data stream. The third data stream is used for determining which of the requests for access to the shared resource may be granted. The arbitration method further comprises generating a final data stream according to the third data stream based on a priority sequence of the data processing devices. The final data stream is used for identifying which of the requests is confirmed to be granted.

The present invention provides an arbitration circuit for arbitrating requests from a plurality of data processing devices for access to a shared resource. The arbitration circuit has a first module, a second module, and a third module. The first module is used to generate a first data stream according to current service statuses of the data processing devices. The first data stream is used for respectively identifying whether the data processing devices are currently serviced. The second module is used to receive the second data stream, and the second data stream is used for identifying whether the data processing devices issue any request for access to the shared resource. The second module is further used to perform a plurality of AND operations on corresponding bits of the first data stream and the second data stream in parallel to generate a plurality of bits of a third data stream. The third data stream is used for determining which of the requests for access to the shared resource may be granted. The third module is used to generate a final data stream according to the third data stream based on a priority sequence of the data processing devices, and the final data stream is used for identifying which of the requests is confirmed to be granted.

In an embodiment of the present invention, the step of generating the first data stream comprises generating a shorter data stream according to the current service statuses of the data processing devices and expanding the shorter data stream to be the first data stream. A number of bits of the shorter data stream is equal to a total number of the data processing devices, and a number of bits of the first data stream is greater than the total number of the data processing devices.

In an embodiment of the present invention, each of the bits of the shorter data stream is corresponding to one of the data processing devices and used for identifying whether the corresponding one of the data processing devices is currently serviced.

In an embodiment of the present invention, the shorter data stream is a data stream having (N+1) bits represented by G[N:0], where N is equal to a result of subtracting 1 from the total number of the data processing devices. G[m]=1 indicates that the m^{th} data processing device is currently serviced, where N≧m≧0. Only one of the (N+1) bits of G[N:0] is equal to 1.

In an embodiment of the present invention, each of the bits of the first data stream is corresponding to one of the data processing devices and used for identifying whether the corresponding one of the data processing devices is permitted to be an allowed candidate data processing device.

In an embodiment of the present invention, the first data stream is a data stream having (2N+1) bits represented by A[2N:0], where N is equal to the result of subtracting 1 from the total number of the data processing devices. When the m^{th} data processing device is currently serviced, the m^{th} to (m+N)^{th} bits of the (2N+1) bits of A[2N:0] are equal to 1, where N≧m≧0.

In an embodiment of the present invention, each of the bits of the second data stream is corresponding to one of the data processing devices and used for identifying whether the corresponding one of the data processing devices issues any request for access to the shared resource.

In an embodiment of the present invention, the second data stream is a data stream having (N+1) bits represented by R[N:0], where N is equal to a result of subtracting 1 from the total number of the data processing devices. When R[x]=1, it represents that the x^{th} data processing device issues a request for access to the shared resource, where N≧x≧0.

In an embodiment of the present invention, each of the bits of the third data stream is corresponding to one of the data processing devices and used for identifying whether the request from the corresponding one of the data processing devices for access to the shared resource may be granted.

In an embodiment of the present invention, the third data stream is a data stream having (2N+1) bits represented by B[2N:0], where N is equal to a result of subtracting 1 from the total number of the data processing devices. When B[x]=1, it represents that the request from the x^{th} data processing device for access to the shared resource may be granted, where N≧x≧0. When B[y]=1, it represents that the request from the (y−(N+1))^{th} data processing device for access to the shared resource may be granted, where 2N≧y≧N+1.

In an embodiment of the present invention, the first data stream is a data stream having (2N+1) bits represented by A[2N:0], the second data stream is a data stream having (N+1) bits represented by R[N:0]. B[y′]=A[y′]·R[z], where 2N≧y′≧0. When N≧y′≧0, z=y′. When 2N≧y′≧(N+1), z=(y′−N−1).

In an embodiment of the present invention, each of the bits of the final data stream is corresponding to one of the data processing devices and used for identifying whether the request from the corresponding one of the data processing devices for access to the shared resource is confirmed to be granted.

In an embodiment of the present invention, the final data stream is a data stream having (N+1) bits represented by G′[N:0], where N is equal to a result of subtracting 1 from the total number of the data processing devices. G′[m]=1 indicates that the request of the m′^{th} data processing device is confirmed to be granted, where N≧m′≧0. Only one of the (N+1) bits of G′[N:0] is equal to 1.

In an embodiment of the present invention, the step of generating the final data stream comprises: excluding bits corresponding to the data processing devices with lower priority among the data processing devices which may be granted, from the third data stream according to the priority sequence of the data processing devices, so as to generate a fourth data stream for identifying the data processing device with the highest priority among the data processing devices which may be granted; and generating the final data stream according to the fourth data stream.

In an embodiment of the present invention, each of the bits of the fourth data stream is corresponding to one of the data processing devices and used for identifying whether the corresponding one of the data processing devices has the highest priority.

In an embodiment of the present invention, the fourth data stream is a data stream having (2N+1) bits represented by C[2N:0], where N is equal to a result of subtracting 1 from the total number of the data processing devices. C[x]=1 indicates that the x^{th} data processing device has the highest priority, where N≧x≧0. When C[y]=1, the y^{th} data processing device has the highest priority, where 2N≧y≧N+1.

In an embodiment of the present invention, the third data stream is a data stream having (2N+1) bit represented by B[2N:0]. When 2N≧P≧N+1, if B[P]=1 and all bits of B[(P−N):(P−1)] are 0, then C[P]=1, otherwise C[P]=0. When N≧P≧1, if B[P]=1 and all bits of B[0:(P−1)] are 0, then C[P]=1, otherwise C[P]=0.

In an embodiment of the present invention, the step of generating the final data stream according to the fourth data stream comprises: shortening the fourth data stream to be the final data stream. The number of bits of the fourth data stream is greater than the total number of the data processing devices, and a number of bits of the final data stream is equal to the total number of the data processing devices.

In an embodiment of the present invention, the step of shortening the fourth data stream to be the final data stream comprises: performing a plurality of OR operations on a plurality of the bits of the fourth data stream in parallel, so as to generate the final data stream. The bits performed by each of the OR operations are corresponding to the same data processing device.

In an embodiment of the present invention, the fourth data stream is a data stream having (2N+1) bits represented by C[2N:0], and the final data stream is a data stream having (N+1) bits represented by G′[N:0], wherein N is equal to a result of subtracting 1 from the total number of the data processing devices. G′[N]=C[N], and G′[Q] is equal to a result of the OR operation performed on C[Q] and C[Q+N+1], where (N−1)≧Q≧0.

In an embodiment of the present invention, the first module generates a shorter data stream according to the current service statuses of the data processing devices and expands the shorter data stream to be the first data stream. A number of bits of the shorter data stream is equal to the total number of the data processing devices, and a number of bits of the first data stream is greater than the total number of the data processing devices.

In an embodiment of the present invention, the second module comprises a plurality of AND gates, and each of the AND gates performs an AND operation on a corresponding bit of the first data stream and a corresponding bit of the second data stream to output a corresponding bit of the third data stream.

In an embodiment, the third module comprises a first sub-module and a second sub-module. The first sub-module is used for excluding bits corresponding to the data processing devices with lower priority among the data processing devices which may be granted, from the third data stream according to the priority sequence of the data processing devices, so as to generate a fourth data stream for identifying the data processing device with the highest priority among the data processing devices which may be granted. The second sub-module is used to generate the final data stream according to the fourth data stream.

In an embodiment, the first sub-module comprises a plurality of AND gates, and each of the AND gates performs an AND operation according to a plurality of bits obtained from the third data stream to generate a corresponding bit of the fourth data stream.

In an embodiment, the plurality of bits includes a corresponding bit of the third data stream and inverted bit(s) of one or more bits of the third data stream, and the one or more bits have lower priority than the corresponding bit of the third data stream.

In an embodiment, the second sub-module comprises a plurality of OR gates, and each of the OR gates performs an OR operation on a plurality of the bits of the fourth data stream, so as to generate a corresponding bit of the final data stream. The bits performed by each of the OR gates are corresponding to the same data processing device.

Based on the above, the arbitration circuit described in the embodiments performs a plurality of AND operations on corresponding bits of the first data stream and the second data stream in parallel to generate a plurality of bits of the third data stream and the final data stream in parallel. Accordingly, the arbitration time of the arbitration circuit could be reduced, and the efficiency of arbitration circuit while arbitrating the requests could be improved.

In order to make the aforementioned and other features and advantages more comprehensible, embodiments accompanying figures are described in detail below.

### BRIEF DESCRIPTION OF THE DRAWINGS

The accompanying drawings constituting a part of this specification are incorporated herein to provide a further understanding of the invention. Here, the drawings illustrate embodiments of the invention and, together with the description, serve to explain the principles of the invention.

FIG. 1 is a functional block diagram of a conventional arbitration circuit applied to a plurality of data processing devices and a shared resource.

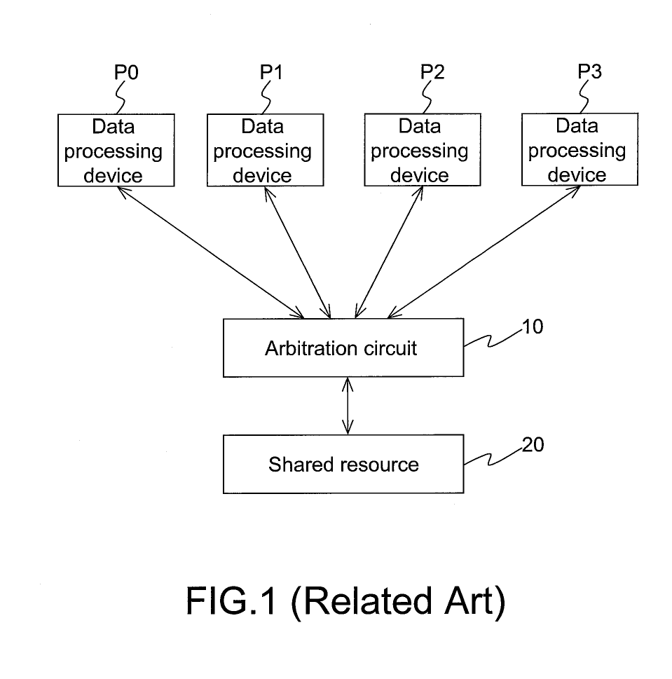

FIG. 2 illustrates the sequence of owing the highest priority when the arbitration circuit processes the requests from the data processing devices by the round-robin method.

FIG. 3 illustrates the pseudo-code executed by the arbitration circuit of FIG. 1 while arbitrating the requests from the data processing devices.

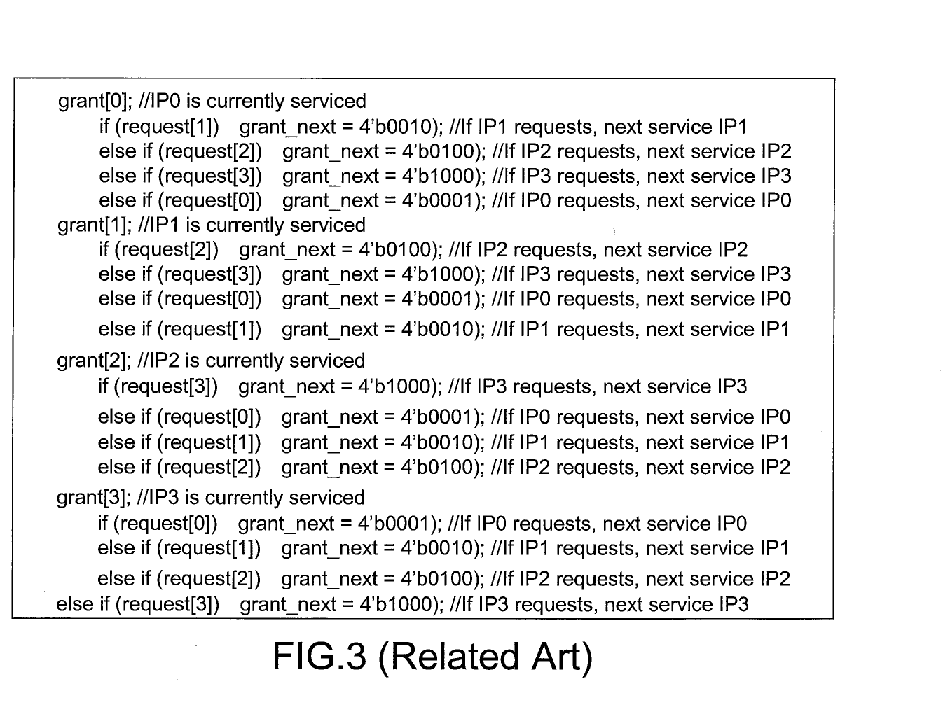

FIG. 4 is a functional block diagram of an arbitration circuit applied to a plurality of data processing devices and to a shared resource according to an embodiment of the present invention.

FIG. 5 is a functional block circuit diagram of the arbitration circuit in FIG. 4.

FIG. 6 is a flowchart of an arbitration method according to an embodiment of the present invention.

FIG. 7 is a functional block diagram of an arbitration circuit applied to a plurality of data processing devices and to a shared resource according to an embodiment of the present invention.

FIG. 8 illustrates the sequence of owing the highest priority when the arbitration circuit in FIG. 7 processes the requests from the data processing devices by the round-robin method.

FIG. 9 is a functional block circuit diagram of the arbitration circuit in FIG. 7.

### DESCRIPTION OF EMBODIMENTS

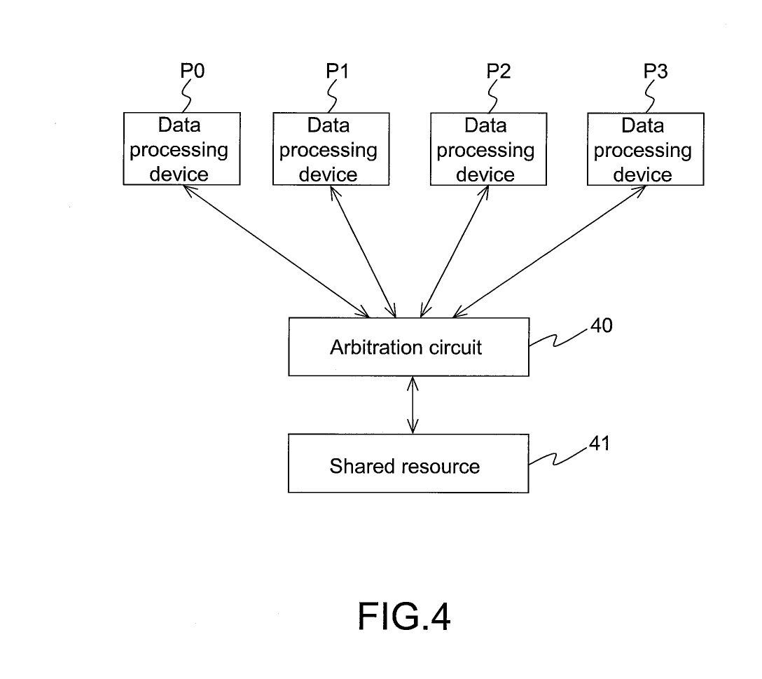

Please refer to FIG. 4, which is a functional block diagram of an arbitration circuit 40 applied to a plurality of data processing devices IP1-IP3 and a shared resource 41 according to an embodiment. As shown in FIG. 4, there is a plurality of data processing devices issue requests to the arbitration circuit 40 for access to the shared resource 41. In the exemplary embodiment, there are four data processing devices IP0, IP1, IP2 and IP3. After the arbitration circuit 40 receives the requests from the data processing devices IP0-IP3, the arbitration circuit 40 processes the requests form the data processing devices IP0-IP3 according to a priority sequence of the data processing devices IP0-IP3 for access to the shared resource 41. In the following descriptions, it would be explained that one of the main features of the arbitration circuit 40 is arbitrating the requests from the data processing devices in a parallel way.

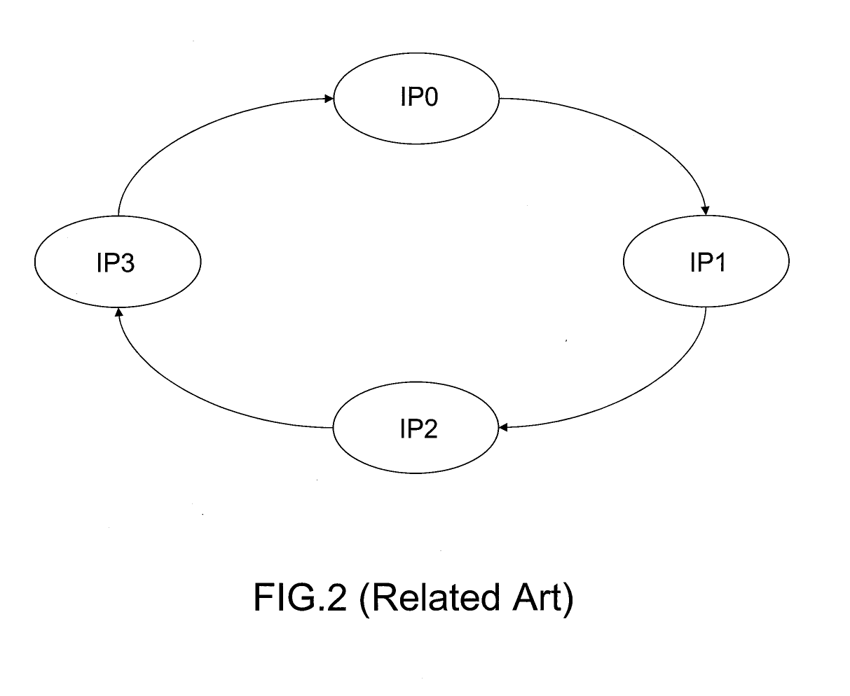

Moreover, various conventional sequences can be adopted to arrange the sequence of the data processing devices IP0-IP3 for obtaining the highest priority from the arbitration circuit 10. Preferably, the sequence, shown in FIG. 2, i.e. IP0→IP1→IP2→IP3→IP0→ . . . , could be adopted. Each of the data processing devices IP0-IP3 obtains the highest priority sequentially based on the sequence, and the request of the data processing device owing the highest priority would be processed firstly. Moreover, when one of the data processing devices obtains the highest priority, the levels of priority of other data processing devices are decreased sequentially. For example, when the data processing device IP0 obtains the highest priority, the priority sequence of the arbitration circuit 40 to process the requests from the data processing devices is IP0→IP1→IP2→IP3; when the data processing device IP1 obtains the highest priority, the priority sequence of the arbitration circuit 40 to process the requests form the data processing devices is IP1→IP2→IP3→IP0; and so on.

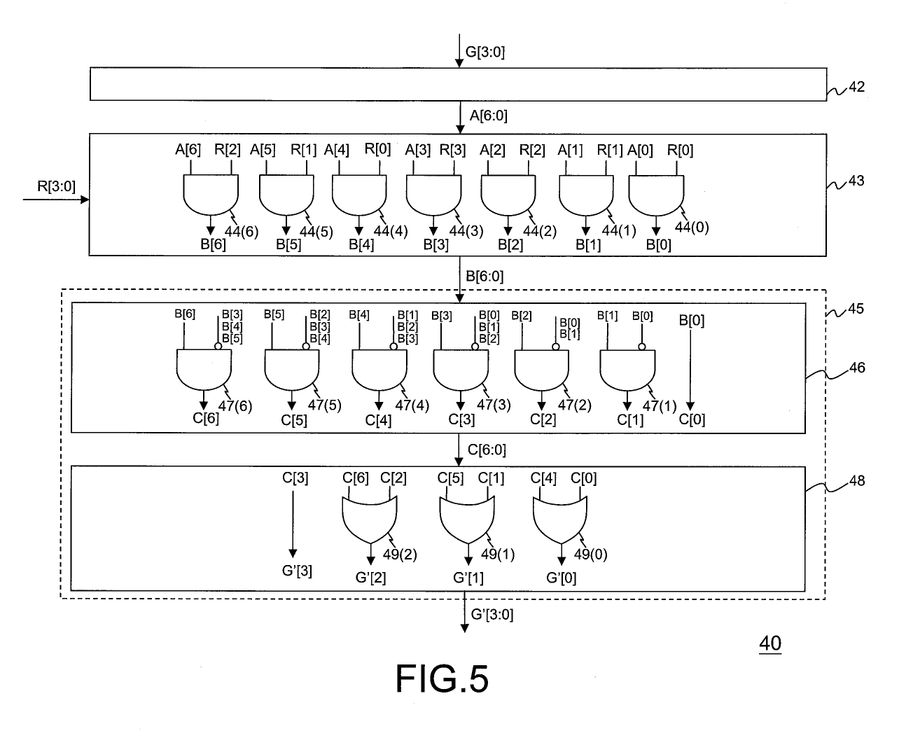

Please refer to FIG. 5, which 5 is a functional block circuit diagram of the arbitration circuit in FIG. 4. The arbitration circuit 40 has a first module 42, a second module 43, and a third module 45. The first module 42 is used to generate a first data stream A[6:0] according to current service statuses of the data processing devices IP0-IP3 and provides the first data stream A[6:0] to the second module 43. The first data stream A[6:0] is used for respectively identifying whether the data processing devices IP0-IP3 are currently serviced by the arbitration circuit 40, and the data processing device serviced by the arbitration circuit 40 is allowed to access to the shared resource 41.

The second module 43 is used to receive the second data stream R[3:0], and the second data stream R[3:0] is used for identifying whether the data processing devices IP0-IP3 issue any request for access to the shared resource 41.

Moreover, the second module 43 is further used to perform a plurality of AND operations on corresponding bits of the first data stream A[6:0] and the second data stream R[3:0] in parallel to generate a plurality of bits of a third data stream B[6:0].

The third data stream B[6:0] is used for determining which of the requests of the data processing devices IP0-IP3 for access to the shared resource 41 may be granted.

The third module 45 generates a final data stream G′[3:0] according to the third data stream B[6:0] based on a priority sequence of the data processing devices IP0-IP3. The final data stream G′[3:0] is used for identifying which of the requests of the data processing devices IP0-IP3 for access the shared resource 41 is confirmed to be granted.

It should be noted that the arbitration circuit 40 performs a plurality of AND operations on corresponding bits of the first data stream A[6:0] and the second data stream R[3:0] in parallel so as to generate a plurality of bits of the third data stream B[6:0] and the final data stream G′[3:0] in parallel. Accordingly, the arbitration time of the arbitration circuit 40 could be reduced, and the efficiency of arbitration circuit 40 for arbitrating the requests could be improved. The detailed structures and operations of the first, second, and third modules and the contents of related data streams are described in detail below.

### The First Module 42 and the First Data Stream A[6:0]

As mentioned previously, the first data stream A[6:0] is used for respectively identifying whether the data processing devices IP0-IP3 are currently serviced. Preferably, the first data stream A[6:0] is a data stream that its number of bits is greater than the total number of the data processing devices IP0-IP3. For example, the first data stream A[6:0] is a data stream having 7 bits. Wherein, the bits A[0] and A[4] are corresponding to the data processing device IP0, the bits A[1] and A[5] are corresponding to the data processing device IP1, the bits A[2] and A[6] are corresponding to the data processing device IP2, and the bit A[3] is corresponding to the data processing device IP3. Moreover, it could be configured to determine which bit is “1” according to the verification sequence of A[0]→A[1]→A[2]→A[3]→A[4]→A[5]→A[6], and it could be configured to determine that the data processing device having the bit firstly determined to be “1” is the data processing device currently serviced by the arbitration circuit 40. For example, if the most significant bit (MSB) and the least significant bit (LSB) of the first data stream A[6:0] are A[6] and A[0] respectively, when the first data stream A[6:0] is “0111100”, based on the verification sequence, the bit firstly determined to be “1” is the bit A[2], such that the data processing device IP2 corresponding to the bit A[2] is the data processing device which is currently serviced by the arbitration circuit 40. For another example, when the first data stream A[6:0] is “0001111”, the bit firstly determined to be “1” is the bit A[0], such that the data processing device IP0 corresponding to the bit A[0] is the data processing device which is currently serviced by the arbitration circuit 40.

In a specific embodiment, the first module 42 generates a shorter data stream G[3:0] firstly according to the current service statuses of the data processing devices IP0-IP3 and then expands the shorter data stream G[3:0] to be the first data stream A[6:0]. The number of bits of the shorter data stream G[3:0] is equal to the total number of the data processing devices IP0-IP3, and the number of bits of the first data stream A[6:0] is greater than the total number of the data processing devices IP0-IP3.

For example, since the total number of the data processing devices IP0-IP3 is 4, the number of bits of the shorter data stream G[3:0] is equal to 4.

Each of the bits of the shorter data stream G[3:0] could be corresponding to one of the data processing devices IP0-IP3.

Preferably, the bit G[0] is corresponding to the data processing device IP0, the bit G[1] is corresponding to the data processing device IP1, the bit G[2] is corresponding to the data processing device IP2, and the bit G[3] is corresponding to the data processing device IP3. In each time, only one of the bits of G[3:0] is equal to 1, and the other bits of G[3:0] are “0”. The data processing device IP0 corresponding to the bit of the shorter data stream G equal to “1” is the data processing device which is currently serviced by the arbitration circuit 40. For example, if the MSB and the LSB of the shorter data stream G[3:0] are G[3] and G[0] respectively, when the shorter data stream G[3:0] is “0010”, since the bit G[1] is equal to “1”, the data processing device IP1 corresponding to the bit G[1] is the data processing device which is currently serviced by the arbitration circuit 40. For another example, when the shorter data stream G[3:0] is “1000”, since the bit G[3] is equal to “1”, the data processing device IP3 corresponding to the bit G[3] is the data processing device which is currently serviced by the arbitration circuit 40.

Then, the first module 42 could expand the shorter data stream G[3:0] to be the first data stream A[6:0]. Preferably, when the m^{th} data processing device is currently serviced, the m^{th} to (m+N)^{th} bits of the first data stream A[2N:0] could be configured to be 1, where N is equal to the result of subtracting 1 from the total number of the data processing devices IP0-IPN, and N≧m≧0. For example, since N is equal to 3 in the embodiment, if G[1]=“1”, A[1]=A[2]=A[3]=A[4]=1, and A[0]=A[5]=A[6]=0. Accordingly, the first module 42 could expand the shorter data stream G[3:0] to be the first data stream A[6:0].

### The Second Module 43 and the Second and Third Data Streams R[3:0] and B[6:0]

As mentioned previously, the second data stream R[3:0] is used for identifying whether the data processing devices IP0-IP3 issue any request for access to the shared resource 41. Preferably, each of the bits of the second data stream R[3:0] is corresponding to one of the data processing devices IP0-IP3 and used for identifying whether the corresponding one of the data processing devices IP0-IP3 issues any request for access to the shared resource 41. Specifically, it could be configured such that the bit R[0] is corresponding to the data processing device IP0, the bit R[1] is corresponding to the data processing device IP1, the bit R[2] is corresponding to the data processing device IP2, and the bit R[3] is corresponding to the data processing device IP3. When any one of the data processing devices IP0-IP3 issues the request for access to the shared resource 41, the corresponding bit of the second data stream R[3:0] would be “1”. Conversely, if any bit of the second data stream R[3:0] is “0”, it represents that the corresponding data processing device does not issue a request for access to the shared resource 41.

For example, if the MSB and the LSB of the second data stream R[3:0] are R[3] and R[0] respectively, when the second data stream R[3:0] is “1011”, it represents that the data processing devices IP0, IP1 and IP3 issue the requests for access to the share resource 41, and the data processing device IP2 does not issue the request for access to the share resource 41. For another example, when the second data stream R[3:0] is “0110”, it represents that the data processing devices IP1 and IP2 issue the requests for access to the share resource 41, and the data processing devices IP0 and IP3 do not issue the requests for access to the share resource 41.

As mentioned previously, the third data stream B[6:0] is used for determining which of the requests of the data processing devices IP0-IP3 for access to the shared resource 41 may be granted. Preferably, each of the bits of the third data stream B[6:0] is corresponding to one of the data processing devices IP0-IP3 and used for identifying whether the request issued by the corresponding data processing device for access to the shared resource 41 may be granted. In the embodiment, it could be configured that the bits B[0] and B[4] are corresponding to the data processing device IP0, the bits B[1] and B[5] are corresponding to the data processing device IP1, the bits B[2] and B[6] are corresponding to the data processing device IP2, and the bit B[3] is corresponding to the data processing device IP3. When any bit of the third data stream B[6:0] is “1”, it represents that the request from the data processing device corresponding to the bit for access to the shared resource 41 may be granted.

FIG. 5 also illustrates the detailed structure of an embodiment of the second module 43. As shown in FIG. 5, the second module 43 could comprise a plurality of AND gates 44(0) to 44(6), and each of the AND gates 44(0)-44(6) performs an AND operation on a corresponding bit of the first data stream A[6:0] and a corresponding bit of the second data stream R[3:0] to output a corresponding bit of the third data stream B[6:0].

Specifically, the AND gate 44(0) performs an AND operation on the bit A[0] and the bit R[0] to output the bit B[0]; the AND gate 44(1) performs an AND operation on the bit A[1] and the bit R[1] to output the bit B[1]; the AND gate 44(2) performs an AND operation on the bit A[2] and the bit R[2] to output the bit B[2]; the AND gate 44(3) performs an AND operation on the bit A[3] and the bit R[3] to output the bit B[3]; the AND gate 44(4) performs an AND operation on the bit A[4] and the bit R[0] to output the bit B[4]; the AND gate 44(5) performs an AND operation on the bit A[5] and the bit R[1] to output the bit B[5]; and the AND gate 44(6) performs an AND operation on the bit A[6] and the bit R[2] to output the bit B[6]. Since each of the bits of the third data stream B[6:0] is the result of performing the AND operation on a corresponding bit of the first data stream A[6:0] and a corresponding bit of the second data stream R[3:0], when there is any bit of the third data stream B[6:0] is “1”, it means that the data processing device corresponding to the bit issues a request and is also an allowed candidate data processing device.

### The Third Module 45 and the Final Data Stream G′[3:0]

As mentioned previously, the final data stream G′[3:0] is used for identifying which of the requests from the data processing devices IP0-IP3 for access to the shared resource 41 is confirmed to be granted. Preferably, each of the bits of the final data stream G′[3:0] is corresponding to one of the data processing devices IP0-IP3 and used for identifying whether the request issued by the corresponding data processing device for access to the shared resource 41 is confirmed to be granted. Specifically, the four bits G[0], G[1], G[2] and G[3] of the final data stream G′[3:0] are corresponding to the data processing devices IP0, IP1, IP2 and IP3 respectively. Only one of the bits of the final data stream G′[N:0] is equal to 1, and the other bits of the final data stream G′[3:0] are equal to “0”. The data processing device corresponding to the bit of “1” is the data processing device which the request thereof is confirmed to be granted. For example, if the bit G′[2] is “1”, it represents that the arbitration circuit 40 selects the data processing device IP2 is the data processing device which the request thereof is confirmed to be granted. In other words, the request issued by the data processing device IP2 for access to the shared resource 41 is confirmed to be granted. Because the arbitration circuit 40 would only allow one of the requests of the data processing devices in each time, there is only one of the bits of the final data stream G′[3:0] equal to “1”.

The third module 45 generates the final data stream G′[3:0] according to, for example, the priority sequence shown in FIG. 2, such that there is only one of the bits of the final data stream G′[3:0] equal to “1”. For example, when the priority sequence is IP2→IP3→IP0→IP1, and the third data stream B[6:0]=“0111000”, according to the third data stream B[6:0], it could be known that the data processing devices IP3, IP0 and IP1 are allowed candidate data processing devices and issue the requests for access to the shared resource 41. Moreover, based on the priority sequence of IP2→IP3→IP0→IP1, the request of the data processing device IP3 would be granted. Therefore, in the above condition, the final data stream G′[3:0] is “1000” for identifying the request of the data processing device IP3 for access the shared resource 41 is confirmed to be granted. For another example, when the priority sequence is IP0→IP1→IP2→IP3, and the third data stream B[6:0]=“0001110”, according to the third data stream B[6:0], it could be known that the data processing devices IP1, IP2 and IP3 are allowed candidate data processing devices and issue the requests for access to the shared resource 41. Moreover, based on the priority sequence of IP0→IP1→IP2→IP3, the request of the data processing device IP1 would be granted. In the condition, the final data stream G′[3:0] is “0010”.

FIG. 5 also illustrates the detailed structure of an embodiment of the third module 45. As shown in FIG. 5, the third module 45 has a first sub-module 46 and a second sub-module 48. The first sub-module 46 is used for excluding the bits corresponding to the data processing devices with lower priority among the data processing devices which may be granted, from the third data stream B[6:0] according to the priority sequence of the data processing devices IP0-IP3, so as to generate a fourth data stream C[6:0]. In other words, the fourth data stream C[6:0] is used for identifying the data processing device with the highest priority from the data processing devices which may be granted. The second sub-module 48 then generates the final data stream G′[3:0] according to the fourth data stream C[6:0]. The detailed structures and related data streams of the first sub-module 46 and the second sub-module 48 are described in detail below.

As mentioned previously, the fourth data stream C[6:0] is used for identifying the data processing device with the highest priority from the data processing devices which may be granted. Preferably, each of the bits of the fourth data stream C[6:0] could be corresponding to one of the data processing devices IP0-IP3. Specifically, the bits C[0] and C[4] are corresponding to the data processing device IP0, the bits C[1] and C[5] are corresponding to the data processing device IP1, the bits C[2] and C[6] are corresponding to the data processing device IP2, and the bit C[3] is corresponding to the data processing device IP3. For example, if the MSB and the LSB of the fourth data stream C[6:0] are C[6] and C[0] respectively, when the fourth data stream C[6:0] is “0000100”, since the bit C[2] is equal to “1”, the data processing device IP2 corresponding to the bit C[2] is the data processing device with the highest priority among the data processing devices which may be granted.

Moreover, the first sub-module 46 excludes bits corresponding to the data processing devices with lower priority among the data processing devices which may be granted, from the third data stream B[6:0] according to, for example, the priority sequence shown in FIG. 2, so as to generate a fourth data stream C[6:0]. For another example, when the priority sequence is IP1→IP2→IP3→IP0, and the third data stream B[6:0]=“0010110”, according to the third data stream B[6:0], it could be known that the data processing devices which may be granted include the data processing devices IP1, IP2 and IP0. Therefore, based on the priority sequence of IP1→IP2→IP3→IP0, the bit corresponding to the data processing device IP1 with the highest priority among the data processing devices IP1, IP2 and IP0 would be retained, and the other two bits corresponding to the data processing devices IP1 and IP0 with lower priority would be excluded. Accordingly, the fourth data stream C[6:0] would be “0000100”.

FIG. 5 also illustrates the detailed structure of an embodiment of the first sub-module 46. As shown in FIG. 5, the first sub-module 46 may include a plurality of AND gates 47(1) to 47(6). Each of the AND gates 47(1)-47(6) is used to perform an AND operation according to a plurality of bits obtained from the third data stream B[6:0] to generate a corresponding bit of the fourth data stream C[6:0]. The plurality of bits generated according to the third data stream B[6:0] include a corresponding bit of the third data stream B[6:0] and inverted bit(s) of one or more bits of the third data stream B[6:0], and the one or more bits have lower priority than the corresponding bit of the third data stream B[6:0].

More specifically, in the embodiments shown in the drawings, the bit B[0] would be inverted and then inputted into the AND gate 47(1) with the bit B[1] to perform the AND operation, so as to generate the bit C[1]. The bits B[0] and B[1] would be inverted and then inputted into the AND gate 47(2) with the bit B[2] to perform the AND operation, so as to generate the bit C[2]. The bits B[0] to B[2] would be inverted and then inputted into the AND gate 47(3) with the bit B[3] to perform the AND operation, so as to generate the bit C[3]. The bits B[1] to B[3] would be inverted and then inputted into the AND gate 47(4) with the bit B[4] to perform the AND operation, so as to generate the bit C[4]. The bits B[2] to B[4]would be inverted and then inputted into the AND gate 47(5) with the bit B[5] to perform the AND operation, so as to generate the bit C[5]. The bits B[3] to B[5] would be inverted and then inputted into the AND gate 47(6) with the bit B[6] to perform the AND operation, so as to generate the bit C[6]. Moreover, the bit C[0] would be equal to the bit B[0]. In other words, the AND gate 47(1) generates the bit C[1] according to the bits B[0] to B[1]; the AND gate 47(2) generates the bit C[2] according to the bits B[0] to B[2]; the AND gate 47(3) generates the bit C[3] according to the bits B[0] to B[3]; the AND gate 47(4) generates the bit C[4] according to the bits B[1] to B[4]; the AND gate 47(5) generates the bit C[5] according to the bits B[2] to B[5]; and the AND gate 47(6) generates the bit C[6] according to the bits B[3] to B[6].

FIG. 5 also illustrates the detailed structure of an embodiment of the second sub-module 48. As shown in FIG. 5, the second sub-module 48 may comprise a plurality of OR gates 49(0) to 49(2), and each of the OR gates 49(0)-49(2) performs an OR operation on a plurality of the bits of the fourth data stream C[6:0], so as to generate a corresponding bit of the final data stream G′[3:0]. The bits performed by each of the OR gates 49(0)-49(2) are corresponding to the same data processing device. More specifically, the OR gate 49(0) performs the OR operation on the bits C[0] and C[4] to generate the bit G′[0]. The OR gate 49(1) performs the OR operation on the bits C[1] and C[5] to generate the bit G′[1]. The OR gate 49(2) performs the OR operation on the bits C[2] and C[6] to generate the bit G′[2]. Moreover, the bit G′[3] would be equal to the bit C[3].

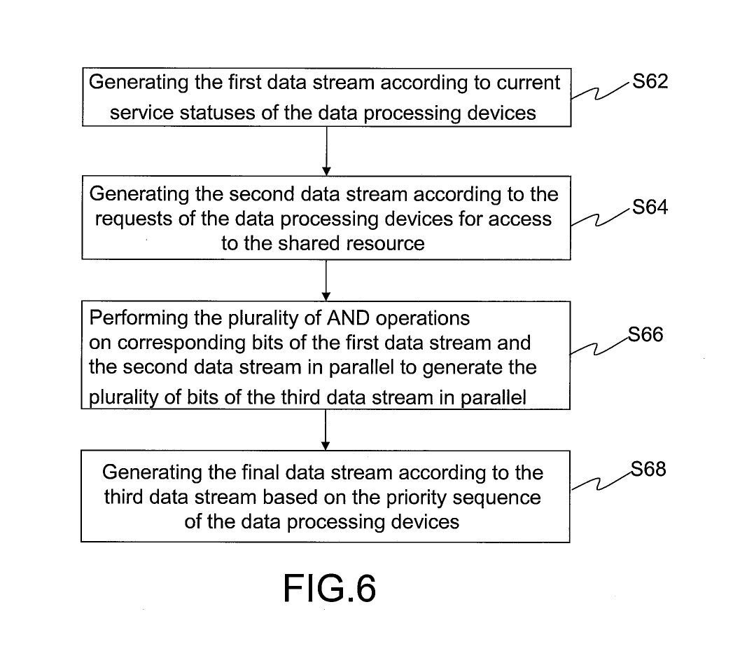

Please refer to FIG. 6 with reference of FIGS. 4 and 5. FIG. 6 is a flowchart of an arbitration method according to an embodiment of the present invention. The arbitration method illustrated in FIG. 6 is used for arbitrating the requests from the plurality of data processing devices IP0-IP3 for access to the shared resource 41. In step S62, the first module 42 generates the first data stream A[6:0] according to current service statuses of the data processing devices IP0-IP3, and the first data stream A[6:0] is used for respectively identifying whether the data processing devices IP0-IP3 are currently serviced. In step S64, the arbitration circuit 40 generates the second data stream R[3:0] according to the requests of the data processing devices IP0-IP3 for access to the shared resource 41. The second data stream R[3:0] is used for identifying whether requests are issued by the data processing devices IP0-IP3 for access to the shared resource 41. In step S66, the second module 43 performs the plurality of AND operations on corresponding bits of the first data stream A[6:0] and the second data stream R[3:0] in parallel to generate the plurality of bits of the third data stream B[6:0] in parallel. The third data stream B[6:0] is used for determining which of the requests of the data processing devices IP0-IP3 for access to the shared resource 41 may be granted. In step S68, the third module 45 generates the final data stream G′[3:0] according to the third data stream B[6:0] based on the priority sequence of the data processing devices IP0-IP3. The final data stream G′[3:0] is used for identifying which of the requests of the data processing device IP0-IP3 for access to the shared resource 41 is confirmed to be granted.

Compared with the serial determination of the arbitration circuit in the prior art which causes long determination time and low efficiency, the arbitration circuit 40 described in the embodiments performs the plurality of AND operations on corresponding bits of the first data stream A[6:0] and the second data stream R[3:0] in parallel to generate the plurality of bits of the third data stream B[6:0] and the final data stream G′[3:0] in parallel. Accordingly, the arbitration time of the arbitration circuit 40 could be reduced comparatively, and the efficiency of arbitration circuit 40 to arbitrate the requests could be improved relatively.

It should be noted that the four data processing devices IP0-IP3 are used to describe the above exemplary embodiments. However, the present invention is not limited thereto. Those ordinarily skilled in the art shall understand that the present invention is also suitable to arbitrate the requests from the data processing devices of other numbers.

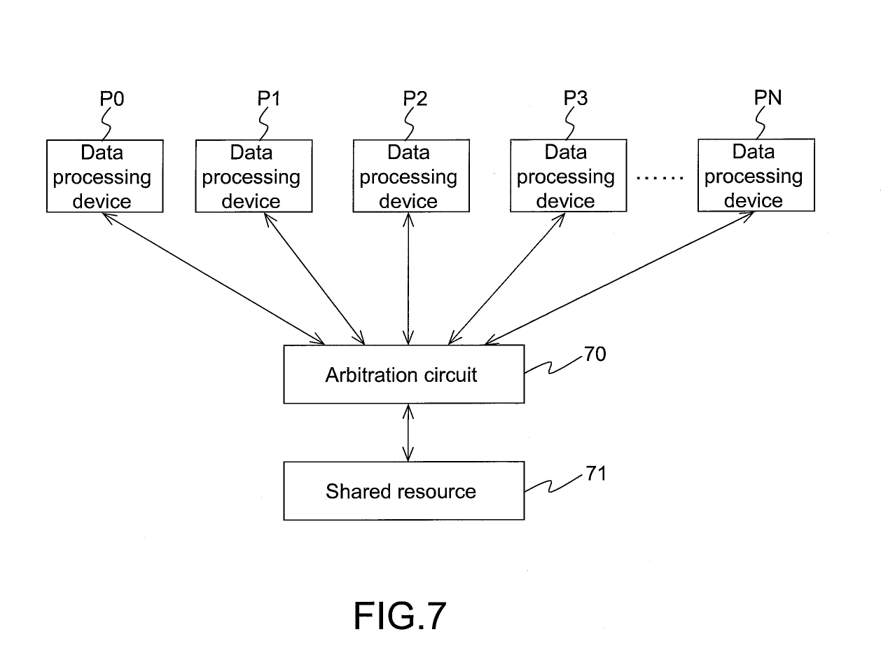

Please refer to FIG. 7, which is a functional block diagram of an arbitration circuit 70 applied to a plurality of data processing devices IP1 to IPN and a shared resource 71 according to an embodiment. N is a positive integer. The data processing devices IP0 to IPN could issue requests to the arbitration circuit 70 respectively for access to the shared resource 71. After the arbitration circuit 70 receives the requests from the data processing devices IP0-IPN, the arbitration circuit 70 arbitrates the requests form the data processing devices IP0-IPN according to a priority sequence of the data processing devices IP0-IPN for access to the shared resource 71. The arbitration circuit 70 also arbitrates the requests from the data processing devices IP0-IPN in the parallel way.

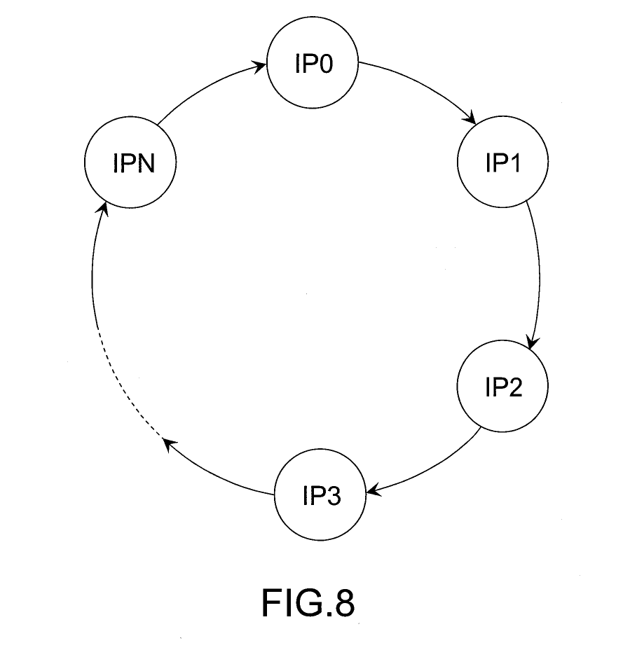

Moreover, various conventional sequences can be adopted to arrange the sequence of the data processing devices IP0-IPN for obtaining the highest priority from the arbitration circuit 70. Preferably, the sequence shown in FIG. 8, i.e. IP0→IP1→IP2→IP3→ . . . →IPN→IP0, could be adopted. Each of the data processing devices IP0-IPN owns the highest priority sequentially based on the sequence, and the request of the data processing device owing the highest priority would be processed firstly. Moreover, when one of the data processing devices obtains the highest priority, the levels of priority of other data processing devices are decreased sequentially. For example, when the data processing device IP0 obtains the highest priority, the priority sequence of the arbitration circuit 70 to process the requests form the data processing devices is IP0→IP1→IP2→IP3→ . . . →IPN. For another example, when the data processing device IP1 obtains the highest priority, the priority sequence of the arbitration circuit 70 to process the requests form the data processing devices is IP1→IP2→IP3→ . . . →IPN→IP0. When any of the other data processing devices obtains the highest priority, the priority sequence of the arbitration circuit 70 to process the requests form the data processing devices could be determined similarly.

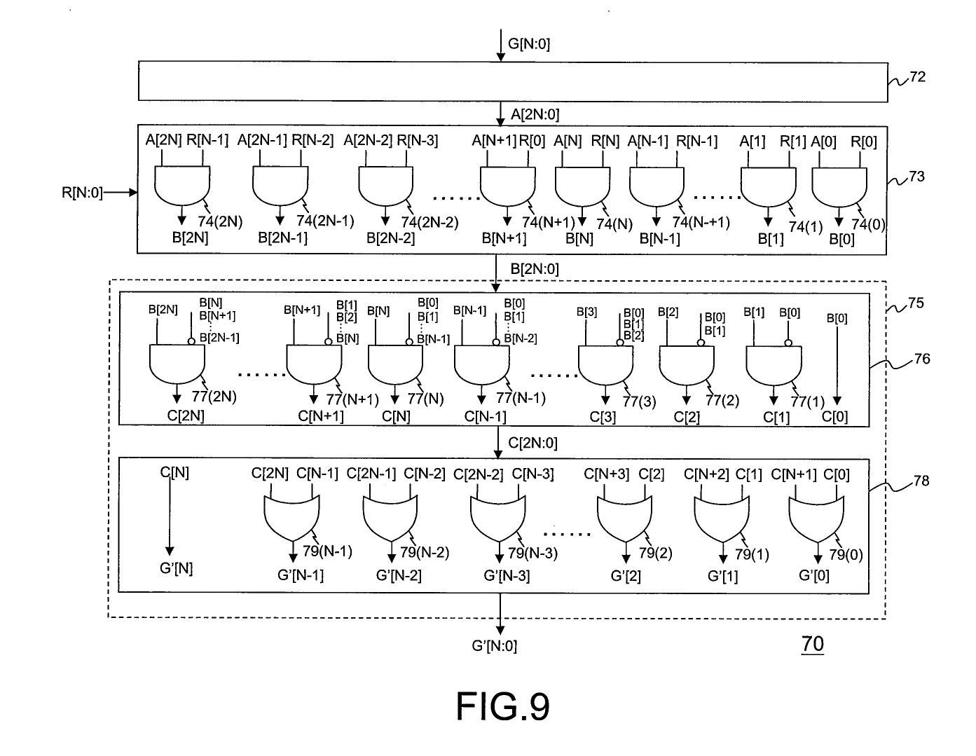

Please refer to FIG. 9, which 9 is a functional block circuit diagram of the arbitration circuit 70 in FIG. 7. The arbitration circuit 70 has a first module 72, a second module 73, and a third module 75. The first module 73 is used to generate a first data stream A[2N:0] according to current service statuses of the data processing devices IP0 to IPN. The first data stream A[2N:0] is used for respectively identifying whether the data processing devices IP0-IPN are currently serviced by the arbitration circuit 70, and the data processing device serviced by the arbitration circuit 70 is allowed to access to the shared resource 71. In the embodiment, the first data stream is a data stream having (2N+1) bits represented by A[2N:0], and N is equal to the result of subtracting 1 from the total number of the data processing devices IP0-IPN.

The second module 73 is used to receive the second data stream R[N:0], and the second data stream R[N:0] is used for identifying whether the data processing devices IP0-IPN issue any request for access to the shared resource 71. Moreover, the second module 73 is further used to perform a plurality of AND operations on corresponding bits of the first data stream A[2N:0] and the second data stream R[N:0] in parallel to generate a plurality of bits of a third data stream B[2N:0] and provide the plurality of bits of the third data stream B[2N:0] to the third module 75. The third data stream B[2N:0] is used for determining which of the requests of the data processing resource IP0-IPN for access to the shared resource 71 may be granted.

The third module 75 generates a final data stream G′[N:0] according to the third data stream B[2N:0] based on a priority sequence of the data processing devices IP0-IPN. The final data stream G′[N:0] is used for identifying which of the requests of the data processing devices IP0-IPN for access the shared resource 71 is confirmed to be granted.

It should be noted that the arbitration circuit 70 performs a plurality of AND operations on corresponding bits of the first data stream A[2N:0] and the second data stream R[N:0] in parallel so as to generate a plurality of bits of the third data stream B[2N:0] and the final data stream G′[N:0] in parallel. Accordingly, as compared with the serial determination of the arbitration circuit in the prior art, the arbitration time of the arbitration circuit 70 could be reduced comparatively, and the efficiency of arbitration circuit 70 for arbitrating the requests could be improved relatively. The detailed structures and operations of the first module 72, the second module 73, and third module 75 and the contents of related data streams are described in detail below.

### The First Module 72 and the First Data Stream A[2N:0]

As mentioned previously, the first data stream A[2N:0] is used for respectively identifying whether the data processing devices IP0-IPN are currently serviced. Preferably, the first data stream A[2N:0] is a data stream that its number of bits is greater than the total number of the data processing devices IP0-IPN. For example, the first data stream A[2N:0] is a data stream having (2N+1) bits.

Moreover, during the process of generating the first data stream A[2N:0], the first module 72 firstly generates a shorter data stream G[N:0] according to the current service statuses of the data processing devices IP0-IPN, wherein a number of bits of the shorter data stream G[N:0] is equal to a total number of the data processing devices IP0-IPN. The total number of the data processing devices IP0-IPN is (N+1), and the shorter data stream is a data stream having (N+1) bits represented by G[N:0]. Then, the first module 72 expands the shorter data stream G[N:0] to be the first data stream A[2N:0], wherein a number of bits of the first data stream A[2N:0] is greater than the total number of the data processing devices IP0-IPN.

In an embodiment of the present invention, each of the bits of the shorter data stream G[N:0] is corresponding to one of the data processing devices IP0-IPN and used for identifying whether the corresponding one of the data processing devices IP0-IPN is currently serviced. For example, G[m]=1 indicates that the m^{th} data processing device is currently serviced, N≧m≧0, and only one of the (N+1) bits of G[N:0] is equal to 1. In other words, only one of the data processing devices IP0-IPN is currently serviced at the same time.

Moreover, when the m^{th} data processing device is currently serviced, the m^{th} to (m+N)^{th} bits of the first data stream A[2N:0] are 1, and the other bits are 0, where N≧m≧0. For example, when the data processing device P2 is currently serviced, the 2^{nd} to (2+N)^{th} bits of the first data stream A[2N:0] are 1, and the other bits are 0. Accordingly, the total number of the bits having a value of 1 in the first data stream A[2N:0] is equal to the total number of the data processing devices IP0-IPN. Moreover, each of the data processing devices corresponding to the bits having the value of 1 in the first data stream A[2N:0] is an allowed candidate data processing device, and the request issued by the allowed candidate data processing device may be granted by the arbitration circuit 70. More specifically, each of the bits of the first data stream A[2N:0] is corresponding to one of the data processing devices IP0-IPN and used for identifying whether the corresponding one of the data processing devices IP0-IPN is permitted to be one of the allowed candidate data processing devices. In an embodiment of the present invention, the bit A[m] and the bit A[m+N] are corresponding to an identical data processing device.

### The Second Module 73 and the Second and Third Data Streams R[N:0] and B[2N:0]

As mentioned previously, the second data stream R[N:0] is used for identifying whether the data processing devices IP0-IPN issue any request for access to the shared resource 71. Preferably, the second data stream is a data stream having (N+1) bits represented by R[N:0], and each of the bits of the second data stream R[N:0] is corresponding to one of the data processing devices IP0-IP3 and used for identifying whether the corresponding one of the data processing devices IP0-IP3 issues any request for access to the shared resource 71. Preferably, when R[x]=1, it represents that the xth data processing device issues a request for access to the shared resource 71, where N≧x≧0. Conversely, when R[x]=0, it represents that the x^{th} data processing device does not issue any request for access to the shared resource 71.

As mentioned previously, the third data stream B[2N:0] is used for determining which of the requests of the data processing devices IP0-IPN for access to the shared resource 71 may be granted. Preferably, the third data stream is a data stream having (2N+1) bits represented by B[2N:0]. When B[x]=1, it represents that the request from the x^{th} data processing device for access to the shared resource may be granted, where N≧x≧0. When B[y]=1, it represents that the request from the (y−(N+1))^{th} data processing device for access to the shared resource may be granted, where 2N≧y≧N+1.

As mentioned previously, the second module 73 is further used to perform the plurality of AND operations on corresponding bits of the first data stream A[2N:0] and the second data stream R[N:0] in parallel to generate a plurality of bits of the third data stream B[2N:0] in parallel. Preferably, B[y′]=A[y′]·R[z], where 2N≧y′≧0. When N≧y′≧0, z=y′; and when 2N≧y′≧(N+1), z=(y′−N−1).

FIG. 9 also illustrates the detailed structure of an embodiment of the second module 73. As shown in FIG. 9, the second module 73 could comprise a plurality of AND gates 74(0) to 74(2N), and each of the AND gates 74(0)-74(2N) performs an AND operation on a corresponding bit of the first data stream A[2N:0] and a corresponding bit of the second data stream R[N:0] to output a corresponding bit of the third data stream B[2N:0]. For example, the AND gate 74(2N−2) outputs the bit B[2N−2] according to the bit A[2N−2] and the bit R[N−3].

### The Third Module 75 and the Final Data Stream G′[N:0]

As mentioned previously, the final data stream G′[2N:0] is used for identifying which of the requests from the data processing devices IP0-IPN for access to the shared resource 71 is confirmed to be granted. Preferably, each of the bits of the final data stream G′[N:0] is corresponding to one of the data processing devices IP0-IPN and used for identifying whether the request issued by the corresponding data processing device for access to the shared resource 71 is confirmed to be granted. The final data stream is a data stream having (N+1) bits represented by G′[N:0]. When G′[m]=1, it indicates that the request of the m′^{th} data processing device is confirmed to be granted, where N≧m′≧0. Moreover, because the arbitration circuit 70 would only allow one of the requests of the data processing devices for access to the shared resource 71 in each time, there is only one of the bits of the final data stream G′[N:0] equal to “1”.

FIG. 9 also illustrates the detailed structure of an embodiment of the third module 75. As shown in FIG. 9, the third module 75 has a first sub-module 76 and a second sub-module 78. The first sub-module 76 excludes the bits corresponding to the data processing devices with lower priority among the data processing devices which may be granted, from the third data stream B[2N:0] according to, for example, the priority sequence shown in FIG. 8, so as to generate a fourth data stream C[2N:0]. The fourth data stream C[2N:0] is used for identifying the data processing device with the highest priority from the data processing devices which may be granted. The second sub-module 78 then generates the final data stream G′[N:0] according to the fourth data stream C[2N:0]. The detailed structures and related data streams of the first sub-module 76 and the second sub-module 78 are described in detail below.

As mentioned previously, the fourth data stream C[2N:0] is used for identifying the data processing device with the highest priority from the data processing devices which may be granted. Preferably, each of the bits of the fourth data stream C[2N:0] is corresponding to one of the data processing devices IP0-IPN and used for identifying whether the corresponding one of the data processing devices IP0-IPN owns the highest priority. Specifically, the fourth data stream is a data stream having (2N+1) bits represented by C[2N:0], and N is equal to the result of subtracting 1 from the total number of the data processing devices IP0-IPN. When C[x]=1, it represents that the x^{th} data processing device owns the highest priority, where N N≧x≧0. When C[y]=1, the y^{th} data processing device has the highest priority, where 2N≧y≧N+1.

FIG. 9 also illustrates the detailed structure of an embodiment of the first sub-module 76. As shown in FIG. 9, the first sub-module 76 may include a plurality of AND gates 77(1) to 77(2N), and each of the AND gates 77(1)-77(2N) is used to perform an AND operation according to a plurality of bits obtained from the third data stream B [2N:0] to generate a corresponding bit of the fourth data stream C[2N:0]. The plurality of bits include a corresponding bit of the third data stream B[2N:0] and inverted bit(s) of one or more bits of the third data stream B[2N:0], and the one or more bits have lower priority than the corresponding bit of the third data stream B[2N:0].

Taking the AND gate 77(1) for an example, the corresponding bit of the AND gate 77(1) is the bit B[1], and the AND gate 77(1) performs an AND operation to generate the bit C[1] according to the bit B[1] and the inverted bit of the bit B[0]. The bit B[0] has a lower priority than the bit B[1]. Taking the AND gate 77(N) for another example, the corresponding bit of the AND gate 77(N) is the bit B[N], and the AND gate 77(N) performs an AND operation to generate the bit C[N] according to the bit B[N] and the inverted bits of the bits B[0]−B[N−1]. The bits B[0]−B[N−1] have lower priorities than the bit B[N].

Accordingly, when 2N≧P≧N+1, if B[P]=1 and all bits of B[(P−N):(P−1)] are 0, C[P] is equal to 1; otherwise C[P] is equal to 0. Moreover, when N≧P≧1, if B[P]=1 and all bits of B[0:(P−1)] are 0, C[P] is equal to 1; otherwise C[P] is equal to 0. Moreover, the bit C[0] would be equal to the bit B[0]. Furthermore, the bit C[t] and the bit C[t+N+1] are corresponding to an identical data processing device, where N≧t≧0.

FIG. 9 also illustrates the detailed structure of an embodiment of the second sub-module 78. As shown in FIG. 9, the second sub-module 78 may comprise a plurality of OR gates 79(0) to 79(N−1), and each of the OR gates 79(0)-79(N−1) performs an OR operation on a plurality of the bits of the fourth data stream C[2N:0] in parallel, so as to generate a corresponding bit of the final data stream G′[N:0]. The bits performed by each of the OR gates 79(0)-79(N−1) are corresponding to the same data processing device. Preferably, the bit G′[N] is equal to the bit C[N], and the bit G′[Q] is equal to the result of performing an OR operation on the bit C[Q] and the bit C[Q+N+1], where (N−1)≧Q≧0. Taking the OR gate 79(2) for an example, the OR gate 79(2) perform the OR operation on the bits C[2] and C[N+2] to generate the bit G′[2].

Briefly, when the second sub-module 78 generates the final data stream G′[N:0] according to the fourth data stream C[2N:0], the second sub-module 78 shortens the fourth data stream C[2N:0] to be the final data stream G′[N:0]. Wherein, the number of bits of the fourth data stream C[2N:0] is greater than the total number of the data processing devices IP0-IPN, and a number of bits of the final data stream G′[N:0] is equal to the total number of the data processing devices IP0-IPN. Moreover, when the second sub-module 78 shortens the fourth data stream C[2N:0] to be the final data stream G′[N:0], the second sub-module 78 performs a plurality of OR operations on a plurality of the bits of the fourth data stream C[2N:0] in parallel, so as to generate the final data stream G′[N:0]. The bits performed by each of the OR operations of the second sub-module 78 are corresponding to the same data processing device.

In light of the foregoing, the present invention identifies whether the data processing devices are currently serviced respectively according to the first data stream, identifies whether the data processing devices issue any request for access to the shared resource according to the second data stream, determines which of the requests for access to the shared resource may be granted according to the third data stream, and identifies which of the requests for access to the shared resource is confirmed to be granted according to the final data stream. Because the arbitration circuit performs a plurality of AND operations on corresponding bits of the first data stream and the second data stream in parallel to generate a plurality of bits of the third data stream and a plurality of bits of the final data stream, the arbitration time of the arbitration circuit could be reduced, and the efficiency of arbitration circuit to arbitrate the requests could be improved.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An arbitration method for arbitrating requests from a plurality of data processing devices for access to a shared resource, the arbitration method comprising:
generating a first data stream according to current service statuses of the data processing devices, the first data stream being used for respectively identifying whether the data processing devices are currently serviced;
generating a second data stream according to the requests of the data processing devices for access to the shared resource, the second data stream being used for identifying whether the data processing devices issue any request for access to the shared resource;
performing a plurality of AND operations on corresponding bits of the first data stream and the second data stream in parallel to generate a plurality of bits of a third data stream, the third data stream being used for determining which of the requests for access to the shared resource may be granted; and
generating a final data stream according to the third data stream based on a priority sequence of the data processing devices, the final data stream being used for identifying which of the requests is confirmed to be granted.

2. The arbitration method as claimed in claim 1, wherein the step of generating the first data stream comprises:
generating a shorter data stream according to the current service statuses of the data processing devices, wherein a number of bits of the shorter data stream is equal to a total number of the data processing devices; and
expanding the shorter data stream to be the first data stream, wherein a number of bits of the first data stream is greater than the total number of the data processing devices.

3. The arbitration method as claimed in claim 2, wherein each of the bits of the shorter data stream is corresponding to one of the data processing devices and used for identifying whether the corresponding one of the data processing devices is currently serviced.

4. The arbitration method as claimed in claim 3, wherein the shorter data stream is a data stream having (N+1) bits represented by G[N:0], N is equal to a result of subtracting 1 from the total number of the data processing devices, G[m]=1 indicates that the m^{th} data processing device is currently serviced, N≧m≧0, and only one of the (N+1) bits of G[N:0] is equal to 1.

5. The arbitration method as claimed in claim 4, wherein the first data stream is a data stream having (2N+1) bits represented by A[2N:0], N is equal to the result of subtracting 1 from the total number of the data processing devices, and when the m^{th} data processing device is currently serviced, the m^{th} to (m+N)^{th} bits of the (2N+1) bits of A[2N:0] are equal to 1, N≧m≧0.

6. The arbitration method as claimed in claim 1, wherein each of the bits of the first data stream is corresponding to one of the data processing devices and used for identifying whether the corresponding one of the data processing devices is permitted to be an allowed candidate data processing device.

7. The arbitration method as claimed in claim 1, wherein each of the bits of the second data stream is corresponding to one of the data processing devices and used for identifying whether the corresponding one of the data processing devices issues any request for access to the shared resource.

8. The arbitration method as claimed in claim 7, wherein the second data stream is a data stream having (N+1) bits represented by R[N:0], N is equal to a result of subtracting 1 from the total number of the data processing devices, and when R[x]=1, it represents that the x^{th} data processing device issues a request for access to the shared resource, N≧x≧0.

9. The arbitration method as claimed in claim 1, wherein each of the bits of the third data stream is corresponding to one of the data processing devices and used for identifying whether the request from the corresponding one of the data processing devices for access to the shared resource may be granted.

10. The arbitration method as claimed in claim 9, wherein the third data stream is a data stream having (2N+1) bits represented by B[2N:0], N is equal to a result of subtracting 1 from the total number of the data processing devices, when B[x]=1, it represents that the request from the x^{th} data processing device for access to the shared resource may be granted, N≧x≧0; and when B[y]=1, it represents that the request from the (y−(N+1))^{th} data processing device for access to the shared resource may be granted, 2N≧y≧N+1.

11. The arbitration method as claimed in claim 10, wherein the first data stream is a data stream having (2N+1) bits represented by A[2N:0], the second data stream is a data stream having (N+1) bits represented by R[N:0], wherein B[y′]=A[y′]·R[z], 2N≧y′≧0, when N≧y′0, z=y′; and when 2N (N+1), z=(y′−N−1).

12. The arbitration method as claimed in claim 1, wherein each of the bits of the final data stream is corresponding to one of the data processing devices and used for identifying whether the request from the corresponding one of the data processing devices for access to the shared resource is confirmed to be granted.

13. The arbitration method as claimed in claim 12, wherein the final data stream is a data stream having (N+1) bits represented by G′[N:0], N is equal to a result of subtracting 1 from the total number of the data processing devices, G[m]=1 indicates that the request of the m′^{th} data processing device is confirmed to be granted, N≧m′≧0, and only one of the (N+1) bits of G′[N:0] is equal to 1.

14. The arbitration method as claimed in claim 1, wherein the step of generating the final data stream comprises:
excluding bits corresponding to the data processing devices with lower priority among the data processing devices which may be granted, from the third data stream according to the priority sequence of the data processing devices, so as to generate a fourth data stream for identifying the data processing device with the highest priority among the data processing devices which may be granted; and
generating the final data stream according to the fourth data stream.

15. The arbitration method as claimed in claim 14, wherein each of the bits of the fourth data stream is corresponding to one of the data processing devices and used for identifying whether the corresponding one of the data processing devices with the highest priority.

16. The arbitration method as claimed in claim 15, wherein the fourth data stream is a data stream having (2N+1) bits represented by C[2N:0], N is equal to a result of subtracting 1 from the total number of the data processing devices, C[x]=1 indicates that the x^{th} data processing device owns the highest priority, where N≧x≧0; and when C[y]=1, the y^{th} data processing device has the highest priority, where 2N≧y≧N+1.

17. The arbitration method as claimed in claim 16, wherein the third data stream is a data stream having (2N+1) bit represented by B[2N:0], and
when 2N≧P≧N+1, if B[P]=1 and all bits of B[(P−N):(P−1)] are 0, then C[P]=1, otherwise C[P]=0; and
when N≧P≧1, if B[P]=1 and all bits of B[0:(P−1)] are 0, then C[P]=1, otherwise C[P]=0.

18. The arbitration method as claimed in claim 14, wherein the step of generating the final data stream according to the fourth data stream comprises: shortening the fourth data stream to be the final data stream, wherein a number of bits of the fourth data stream is greater than the total number of the data processing devices, and a number of bits of the final data stream is equal to the total number of the data processing devices.

19. The arbitration method as claimed in claim 18, wherein the step of shortening the fourth data stream to be the final data stream comprises:
performing a plurality of OR operations on a plurality of the bits of the fourth data stream in parallel, so as to generate the final data stream, wherein the bits performed by each of the OR operations are corresponding to the same data processing device.

20. The arbitration method as claimed in claim 14, wherein the fourth data stream is a data stream having (2N+1) bits represented by C[2N:0], the final data stream is a data stream having (N+1) bits represented by G′[N:0], wherein N is equal to a result of subtracting 1 from the total number of the data processing devices, G′[N]=C[N], and G′[Q] is equal to a result of the OR operation performed on C[Q] and C[Q+N+1], (N−1)≧Q≧0.

21. An arbitration circuit for arbitrating requests from a plurality of data processing devices for access to a shared resource, the arbitration circuit comprising:
a first module for generating a first data stream according to current service statuses of the data processing devices, the first data stream being used for respectively identifying whether the data processing devices are currently serviced;
a second module for receiving a second data stream, the second data stream being used for identifying whether the data processing devices issue any request for access to the shared resource, and the second module being further used for performing a plurality of AND operations on corresponding bits of the first data stream and the second data stream in parallel to generate a plurality of bits of a third data stream, the third data stream being used for determining which of the requests for access to the shared resource may be granted; and
a third module for generating a final data stream according to the third data stream based on a priority sequence of the data processing devices, the final data stream being used for identifying which of the requests is confirmed to be granted.

22. The arbitration circuit as claimed in claim 21, wherein the first module generates a shorter data stream according to the current service statuses of the data processing devices and expands the shorter data stream to be the first data stream, wherein a number of bits of the shorter data stream is equal to a total number of the data processing devices, and a number of bits of the first data stream is greater than the total number of the data processing devices.

23. The arbitration circuit as claimed in claim 21, wherein the second module comprises a plurality of AND gates, and each of the AND gates performs an AND operation on a corresponding bit of the first data stream and a corresponding bit of the second data stream to output a corresponding bit of the third data stream.

24. The arbitration circuit as claimed in claim 21, wherein the third module comprises:
a first sub-module for excluding bits corresponding to the data processing devices with lower priority among the data processing devices which may be granted, from the third data stream according to the priority sequence of the data processing devices, so as to generate a fourth data stream for identifying the data processing device with the highest priority among the data processing devices which may be granted; and
a second sub-module, for generating the final data stream according to the fourth data stream.

25. The arbitration circuit as claimed in claim 24, wherein the first sub-module comprises a plurality of AND gates, and each of the AND gates performs an AND operation according to a plurality of bits obtained from the third data stream to generate a corresponding bit of the fourth data stream.

26. The arbitration circuit as claimed in claim 25, wherein the plurality of bits include a corresponding bit of the third data stream and inverted bit(s) of one or more bits of the third data stream, and the one or more bits have lower priority than the corresponding bit of the third data stream.

27. The arbitration circuit as claimed in claim 24, wherein the third data stream is a data stream having (2N+1) bits represented by B [2N:0], and the fourth data stream is a data stream having (2N+1) bits represented by C[2N:0], wherein N is equal to a result of subtracting 1 from the total number of the data processing devices, and
when 2N≧P≧N+1, if B[P]=1 and all bits of B[(P−N):(P−1)] are 0, then C[P]=1, otherwise C[P]=0; and
when N≧P≧1, if B[P]=1 and all bits of B[0:(P−1)] are 0, then C[P]=1, otherwise C[P]=0.

28. The arbitration circuit as claimed in claim 24, wherein the second sub-module comprises a plurality of OR gates, each of the OR gates performs an OR operation on a plurality of the bits of the fourth data stream, so as to generate a corresponding bit of the final data stream, wherein the bits performed by each of the OR gates are corresponding to the same data processing device.
